(19) United States
(12) Patent Application Publication
(10) Pub. No.: US 2006/0163933 A1
(43) Pub. Date: Jul. 27, 2006

(54) ADJUSTABLE VEHICLE ARMREST

(75) Inventors: Bogdan Radu, Dearborn, MI (US); Alan George William Dry, Grosse Pointe Woods, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/711,587

(22) Filed: Sep. 27, 2004

(51) Int. Cl. B60N 2/46

(52) U.S. Cl. 297/411.35

(57) ABSTRACT

An adjustable armrest system (14) for a vehicle (12) includes an armrest housing (18) that is mounted within the vehicle (12). The armrest housing has an armrest surface (24). A piston element (32) is coupled to the armrest surface (24). A piston-actuating device (36) is coupled to the piston element (32). A controller is coupled to the piston-actuating device (36) and adjusts the position of the armrest surface (24).

### TECHNICAL FIELD

The present invention relates to automotive interior trim and more particularly, to the adjustment of armrest surfaces within a vehicle.

### BACKGROUND OF THE INVENTION

Armrests are incorporated into vehicles for ergonomic reasons and comfort and convenience of both drivers and passengers. Armrests may be attached to or integrally formed as part of an interior door panel, a seat assembly, or a center console. Some armrests may be stationary, fixed, collapsed, extended, or rotated depending on the mounting location and the system that it is incorporated within.

Adjustable vehicle seats, steering wheels, steering columns, and foot pedals are also incorporated into vehicles to satisfy ergonomic requirements, and driver and passenger convenience and comfort desires. The adjustability of the stated items accommodates differently sized vehicle occupants. For example, a driver seat system may be adjusted in a fore and aft direction to allow the driver access to the steering wheel and foot pedals, as well as to clearly see the exterior environment of the vehicle. As another example, the steering column of a vehicle may be tilted up or down, as well as extended rearwardly or retract forwardly to accommodate different sized individuals.

When a seat is adjusted vertically to lift or lower a seat occupant, the occupant's arm and elbow are also raised or lowered simultaneously with the seat. Presently, the armrests that are incorporated in a door panel or on a center console are not adjustable and do not follow the adjustment of the seat. In general, typical fixed armrests are designed and positioned to satisfy the profile of an average sized driver for that particular vehicle.

However, many drivers do not match or fit within the average driver profile. Also, drivers of the same size often desire different seat positions or orientations. As a result, many drivers undesirably settle with a seat position and a corresponding armrest position that do not correlate with one another and thus do not comfortly satisfy the driver. The undesirable consequential position of the armrest may result in the armrest no longer being used because it is in an uncomfortable position or out of reach of the driver.

One adjustable armrest system that does exist includes an upper surface or armrest surface that may be lifted via a single pneumatic bladder. Air is pumped into or released from the bladder, which raises and lowers an internal edge of the armrest surface. Although this type of armrest system provides some vertical armrest adjustment, it is position and orientation limited. The armrest surface of the bladder type system cannot be tilted in the fore, aft, and either left or right directions relative to a centerline of the armrest surface. Also, the bladder type system is rigid when a significant amount of air pressure exists within the bladder and can be somewhat unstable when a smaller amount of air pressure exists within the bladder. In addition, since the bladder is restrained by a housing to expand in a single direction to lift the armrest surface, the armrest system is limited in its ability to absorb energy due to sudden occupant pressure on the armrest.

Thus, there exists a need for an improved armrest assembly that allows for the adjustment of a normally fixed armrest to satisfy occupant comfort for an increased number of seat positions and differently sized occupants.

### SUMMARY OF THE INVENTION

The present invention overcomes the above-stated disadvantages. In one embodiment of the present invention, an adjustable armrest system for a vehicle is provided. The armrest system includes an armrest housing that is mounted within the vehicle. The armrest housing has an armrest surface. A piston element is coupled to the armrest surface. A piston-actuating device is coupled to the piston element. A controller is coupled to the piston-actuating device and adjusts the position of the armrest surface.

In another embodiment of the present invention, an adjustable armrest system for a vehicle is provided that also includes an armrest housing with an armrest surface residing thereon. A fluid cell and multiple stabilizing members are coupled to the armrest surface. The fluid cell has multiple internal chambers. A pump is coupled to the internal chambers. A controller is coupled to the pump and adjusts the position of a portion of the armrest surface.

The embodiments of the present invention provide several advantages. One such advantage is the ability to adjust the vertical position of an armrest surface independently of and to coincide with relative position of a vehicle seat or other position and orientation adjustable system or component.

Another advantage provided by an embodiment of the present invention is the ability to independently adjust the vertical height of multiple portions of an armrest surface. Thus, allowing the armrest surface to be altered in vertical height and to be tilted in multiple directions.

Additionally, another advantage provided by an embodiment of the present invention is the provision of an armrest surface that is position and orientation adjustable and at the same time stable and capable of absorbing applied kinetic energy in a vertical direction.

The above stated advantages aid in satisfying armrest comfort preferences for various vehicle occupants of different size and having different armrest attributes and performance characteristic desires.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a perspective view of an interior door assembly for a vehicle incorporating an adjustable armrest system in accordance with an embodiment of the present invention;

FIG. 2 is a perspective view of an armrest assembly in a vertically retracted state in accordance with an embodiment of the present invention;

FIG. 2A is a top view of the armrest assembly of FIG. 2;

FIG. 3 is a perspective view of the armrest assembly of FIG. 2 in a vertically extended state;

FIG. 4 is a cross-sectional side view of a piston element assembly in an extended state in accordance with an embodiment of the present invention;

FIG. 5 is a cross-sectional side view of a piston element assembly in a retracted state in accordance with another embodiment of the present invention;

FIG. 6 is a perspective view of an adjustable armrest assembly in an extended state and in accordance with yet another embodiment of the present invention; and

FIG. 7 is a logic flow diagram illustrating a method of adjusting the position of a vehicle armrest surface in accordance with an embodiment of the present invention.

### DETAILED DESCRIPTION

In each of the following figures, the same reference numerals are used to refer to the same components. While the present invention is described primarily with respect to an adjustable armrest surface of an interior door panel, the present invention may be adapted to various vehicle armrest surfaces including armrest surfaces of a set system, a console, a center console, an interior vehicle panel, an interior panel wheel well cover, a door panel, or other armrest surfaces within a vehicle and known in the art. The present invention may be applied to ground-based vehicles, aeronautical vehicles, watercraft, and other vehicle applications. Also, although the present invention is primarily described with the vertical adjustment of an armrest surface and thus the alteration of the height of an armrest, the present invention may be utilized to alter the horizontal width or a combination thereof of an armrest.

In the following description, various operating parameters and components are described for one constructed embodiment. These specific parameters and components are included as examples and are not meant to be limiting.

Referring now to FIG. 1, a perspective view of an interior door assembly 10 for a vehicle 12 incorporating an adjustable armrest system 14 in accordance with an embodiment of the present invention is shown. The armrest system 14 includes an armrest assembly 16 with an armrest housing 18 having an upper portion 20 and a lower portion 22. The upper portion 20 has an armrest surface 24 for resting the arm of a vehicle occupant. A fluid control circuit 26 is coupled to the armrest assembly 16 and adjusts the position and orientation of the armrest surface 24.

The sides 28 of the upper portion 20 extend at least partially over the lower portion 22. The lower portion 22 is stationary and rigidly fastened to the door assembly 10. When actuated the upper portion 20 may change in position and orientation relative to the lower portion 22. The upper portion 20 may be adjusted in a vertical direction and tilted in fore, aft, left, and right directions.

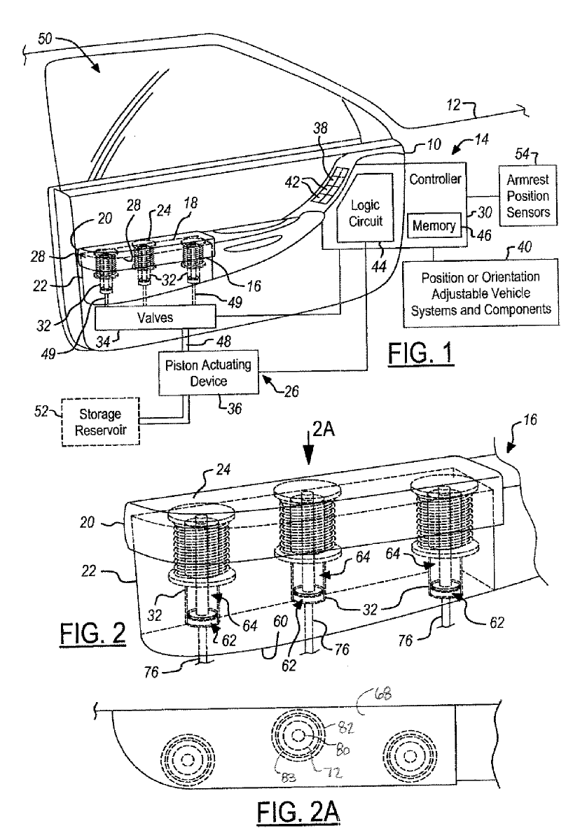

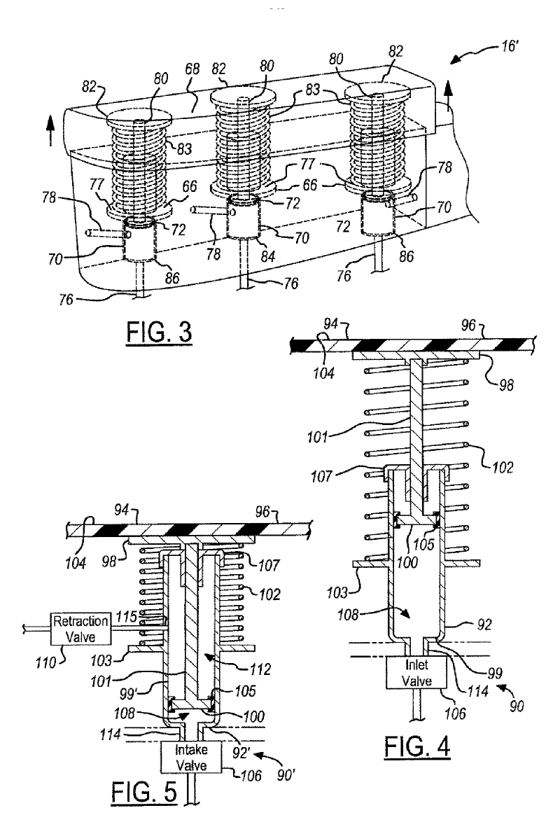

The fluid control circuit 26 may be pneumatic, hydraulic, or a combination thereof. The fluid control circuit 26 includes a controller 30 and a set of piston elements 32 with corresponding sequential valves 34. The piston elements 32 are best seen in and are described with respect to FIGS. 2 and 3. The controller 30 operates the valves 34 via a piston-actuating device 36 when adjusting the armrest surface 24. The controller 30 may be coupled to controls 38 for the manual adjustment of the armrest surface 24. The controller 30 may also adjust the position and orientation of the armrest surface 24 in response to the position or orientation of a vehicle seat or some other adjustable vehicle system or component, such as a steering column, a steering wheel, and foot pedals, as designated by box 40.

The controller 30 is coupled to the armrest assembly 16. The controller 30 may include switches 42 for adjusting the position and orientation of the armrest surface 24. The switches 42 may be coupled to the valves 34 or may be indirectly coupled via a logic circuit 44, as shown. The controller 30 may be located within the door assembly 10, as shown, or elsewhere in the vehicle 12.

The controller 30 may be microprocessor based, such as a computer, and have a central processing unit with associated input and output buses. The controller 30 may be in the form of an application-specific integrated circuit or may be formed of other logic devices known in the art. The controller 30 may be a portion of a central vehicle main control unit, an interactive vehicle dynamics module, or a main safety controller or may be a stand-alone controller as shown.

The controller 30 may have a memory 46 for storing positions and orientations of the armrest surface 24. The memory 46 may be in the form of RAM and/or ROM. The position and orientations may be recalled and used to adjust the armrest surface 24 in relation to the adjustable vehicle systems and components 40.

The valves 34 are coupled between the piston elements 32 and the piston-actuating device 36. The valves 34 are actuated to allow the fluid 48 to pass to and from the piston elements 32. The valves 34 are coupled to the piston elements 32 via fluid lines 49. The valves 34 may be directly coupled to the piston elements 32 without use of the fluid lines 49. Any number of valves 34 may be utilized. The valves 34 may be directly coupled to the switches 42 and contained within a single valve housing (not shown). The valves 34 may simply have open and closed states or may be variable with an infinite number of open settings. The positions of the valves may vary between a fully opened state and a fully closed state.

Although the piston-actuating device 36 is primarily described and shown in the form of a fluid pump, it may be in the form of an electric power supply or electric motor and located within the piston elements 32. When the piston-actuating device 36 is in the form of an electric motor, the valves 34 may not be utilized; the electric motor may be used to extend and retract the piston elements 32.

When in the form of a pump the piston-actuating device 36 may supply and remove the fluid 48 to and from the piston elements 32. The piston-actuating device 36 may be operated in accordance to a predetermined fluid pressure versus time function or diagram. The piston-actuating device 36 may be pneumatic and supply and remove or release air to and from the armrest assembly 16 using air from within the interior cabin 50 or from within a storage reservoir 52. The piston-actuating device 36 may be hydraulic and supply or remove the liquid 48, such as a water or oil based liquid, to and from the armrest assembly 16. Various fluids known in the art may be utilized. The liquid 48 may be in the form of a piezo-electric fluid or some other type of fluid known in the art, which changes in one or more physical characteristics, such as resistance or volume, with the introduction of an electric current. Also, any number of piston-actuating devices may be utilized. The storage reservoir 52 may be located within the door assembly 10 or elsewhere in the vehicle 12.

One or more armrest position sensors 54 may be utilized to determine the position and orientation of the armrest surface 24. The position sensors 54 may be in the form of an infrared sensor, a pressure sensor, a rotary potentiometer, a linear encoder, a linear variable differential transformer, or may be of some other type known in the art. The position sensors 54 may be coupled to the upper portion 20, the lower portion 22, or to the piston elements 32.

Referring now to FIGS. 2-3, perspective views are shown of the armrest assembly 16 in a retracted state and of a modified armrest assembly 16′ in an extended state. The armrest assemblies 16 and 16′ include the piston elements 32 and 32′ residing in and coupled between the upper portion 20 and the lower portion 22. As the piston elements 32 and 32′ are actuated separation distances between the armrest surface 24 and the bottom 60 of the lower portion 22 is altered. Each of the piston elements 32 and 32′ include an extension chamber 62 and a retraction chamber 64.

The piston elements 32 and 32′ have an external lip 66 that rests on and is coupled to an upper surface 68 of the lower portion 22. The piston elements 32 and 32′ include a base or fluid reservoir 70 divided internally by a piston 72 to form the extension chamber 62 and the retraction chamber 64. The extension chamber 62 refers to the area within the reservoir 70 between the piston 72 and the intake port 76. The retraction chamber 64 refers to the area within the reservoir 70 between the piston 72 and the upper side 77 of the reservoir 70. The extension chamber 62 may primarily reside within the upper portion 20 whereas the retraction chamber 64 may reside primarily within the lower portion 22, as illustrated by placement of the external lip 103 in the center of the fluid reservoir 99 of the piston elements 90 and 90′ of FIGS. 4 and 5. The extension chamber 62 and the retraction chamber 64 may have fluid passage ports 74 including an extension port 76 and a retraction port 78. The piston 72 resides within the reservoir 70 and is coupled to a shaft 80 that extends between the piston 72 and the flange 82. The flange 82 is coupled to the upper portion 20. A spring 83 resides on the shaft 80 and between the lip 66 and the flange 82. The spring 83 assists in either the extension or the retraction of the shaft 80 within the reservoir 70.

Although the reservoir 70 is shown as being located within the lower portion 20 and the shaft 80 is shown as being located within the upper portion 20 when the shaft 20 is extended, their locative positions may be switched. The reservoir 70 may be located within the upper portion 20 and the shaft 80 may be located within the lower portion 22.

Even though three piston elements are shown, any number of piston elements may be utilized. The use of three or more piston elements provides physical stability of the upper portion 20 and thus the armrest surface 24. In the embodiment as shown the center piston element 84 is offset from the remaining two piston elements 86 to provide such stability. The use of three or more piston elements also allows for the tilting of the armrest surface 24 in fore, aft, left, and right directions and various combinations thereof. In terms of watercraft, left and right directions refer to port and starboard directions. The use of three piston elements provides the ability to orient the armrest surface 24 as stated with a minimal amount of piston elements. Also, although a single layout and configuration of the piston elements 32 and 32′ are shown, any number of configurations may be utilized. The separation distances between the piston elements 32 and 32′ is maximized within the armrest assembly to provide increased stability.

Referring now to FIGS. 4 and 5, cross-sectional side views of a piston element assembly 90 in an extended state and a piston element assembly 90′ in a retracted state in accordance with an embodiment of the present invention are shown. The piston element assemblies 90 and 90′ include piston elements 92 and 92′, respectively, that are coupled to an upper portion 94 of an armrest housing 96 via a flange 98. The piston elements 90 and 90′ include fluid reservoirs 99 and 99′ with a piston 100 residing therein. The piston 100 is coupled to the shaft flange 98 via the shaft 101.

The piston 100 is translated via the supply or inlet valve 106 and the return or retraction valve 110, as shown in FIG. 4. The inlet valve 106 and the retraction valve 110 may operate as relief valves. The inlet valve 106 is coupled to the extension chamber 108 and the retraction valve 110 is coupled to the retraction chamber 1112. The inlet valve 106 or the retraction valve 110 may be utilized alone or in combination. When the fluid utilized to translate the piston is in the form of air, the inlet valve 106 and the retraction valve 110 may release air into the atmosphere when air is being removed from either the extension chamber 108 or the retraction chamber 112. FIG. 4 is an illustrated example of when a single valve is used alone as both an inlet valve and as a return valve.

A piston seal or ring 105 resides on the piston 100, between the piston 100 and the reservoirs 99 and 99′, and prevents passage of fluid between the extension chamber 108 and the retraction chamber 112. A shaft seal 107 is coupled to the reservoirs 99 and 99′, allows translation of the shaft 101, and prevents passage or leakage of fluid out of the retraction chamber 112 about the shaft 101.

A spring 102 resides between and may be coupled to the lip 103 and the flange 98. The spring 102 may assist in the displacement of the armrest surface 104 of the upper portion 94. The spring 102 may be normally in a retracted or compressed state or in an extended state.

When the spring 102 has a normally compressed state, the retraction valve 110 may not be utilized. The intake valve 106 may be configured to allow the passage of air into the extension chamber 108 and translate the piston 100 towards the upper portion 94. The intake valve 106 may also be configured to allow the passage of air within the extension chamber 108 to be released into the atmosphere or the interior 50, thus translating the piston 100 towards the intake port 114 of the piston element 92 and lowering at least a portion of the upper portion 94.

In one embodiment of the present invention, the spring 102 is normally compressed as to maintain the upper portion 94 in a down state such that as the upper portion 94 is raised spring compression force increases. In operation of the piston element 92, the inlet valve 106 may be opened to allow fluid to enter the extension chamber 108 of the reservoir 99 and raise at least partially the upper portion 94. To retract the piston 100 the inlet valve 106 remains open, but fluid is no longer pumped into the extension chamber 108. Fluid may be pumped out of the extension chamber 108 or compression force of the spring 102 may lower the upper portion 94 and force fluid out of the extension chamber 108.

In operation of the piston element 92′, the inlet valve 106 is opened to allow fluid to enter the extension chamber 108 of the reservoir 99′ and raise at least partially the upper portion 94. To retract the upper portion 94 the inlet valve 106 remains open and the retraction valve 110 is opened. Fluid is pumped into the retraction chamber 112 of the reservoir 99′, through the retraction port 115, to force the piston 100 inward toward the intake port 114 and to remove fluid within the extension chamber 108. To reextend the shaft 101 the retraction valve remains open and fluid is pumped out of the retraction chamber 112 and into the extension chamber 108. The tension or compression force of the spring 102 may be used to lower or raise the upper portion 94 and force the fluid in or out of the extension chamber 108 and the retraction chamber 112.

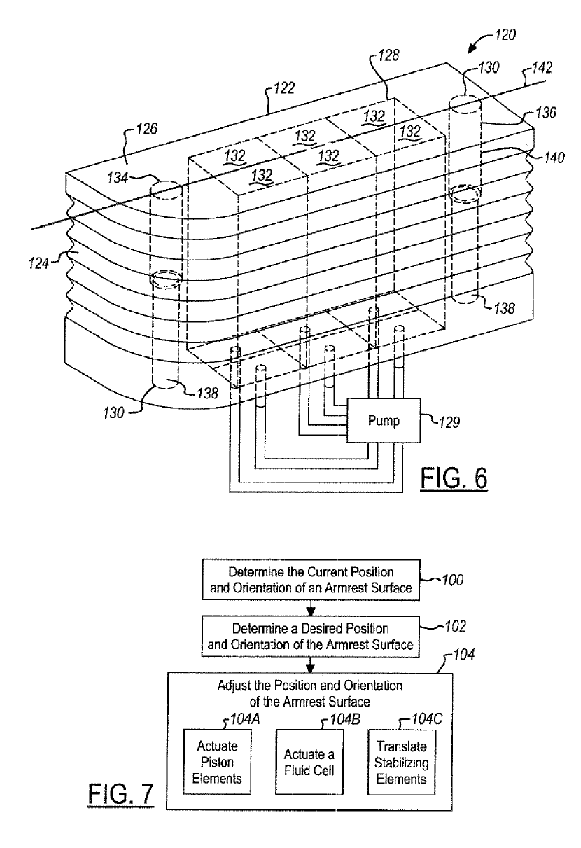

Referring now to FIG. 6, a perspective view of an adjustable armrest assembly 120 in an extended state is shown in accordance with another embodiment of the present invention. The armrest assembly 120 includes an armrest housing 122 having a flexible perimeter wall member 124 and an armrest surface 126. The housing 122 may be as shown, similar to the housing 18 with an upper portion and a lower portion, or may be of some other style known in the art. A fluid cell 128 and a pair of sliding stabilizing elements 130 reside within the housing 122. The armrest surface 126 is raised or lowered by the fluid cell 128 via a pump 129. Fluid is pumped into and removed from the fluid cell 128 when raising and lowering the armrest surface 126.

The fluid cell 128 may be filled with air or liquid. The fluid cell 128 may be formed of various materials and may have one or more internal chambers 132, as shown. The inclusion of more than one chamber allows for the tilting of the armrest surface 126.

The sliding elements 130 provide stability of the armrest surface 126. The sliding elements 130 include a first slider 134 and a second slider 136 that are positioned on different sides of the fluid cell 128. The sliding elements 130 include an inner element 138 and an outer element 140, which slides over the inner element 138. The sliding elements 130 may be of various sizes, shapes, and styles.

The sliding elements 130 may be located along a longitudinal center line 142 of the armrest surface 126 extending in the fore and aft directions, as shown, or in other locations such that the armrest surface 124 is fully adjustable in a vertical direction and allows for the tilting thereof in fore, aft, left, and right directions or in a combination thereof while in various vertical positions. This provides increased flexibility in position and orientation selection. The sliding elements 130 may also be located within or external from the fluid cell 128.

All of the components within the above stated embodiments with respect to FIGS. 1-6 including the housings 18 and 122, the springs 83 and 102, the piston elements 32, 92, and 92′, the shafts 80 and 101, the flanges 82 and 98, the pistons 72 and 100, the lips 66 and 103, and the other listed components may be formed of a plastic material or the like. Forming the stated devices of a plastic material or of other materials having similar collision characteristics, as opposed to for example a metallic material, allows the above-stated assemblies to be incorporated within an automotive door assembly and to satisfy side collision safety requirements.

The flexible perimeter wall member 124 allows the armrest surface 126 to be raised and lowered, as well as to be tilted in various directions. The flexible wall 126 may have accordion style sides that fold or bend, as shown, or may be configured otherwise as known in the art to allow the armrest surface 126 to vary in position and orientation.

The above-described embodiments with respect to FIGS. 1-6 are illustrative examples. The piston elements 32 and 100, the fluid cell 128, and the stabilizing elements 130 may be used in combination and in various configurations. Any number of each of the stated devices may be utilized. Also, the armrest adjusting system 14 and armrest assemblies 16 and 120 may be modified to adjust any number of armrest surfaces.

Referring now to FIG. 7, a logic flow diagram illustrating a method of adjusting the position of a vehicle armrest surface is shown.

In step 100, the controller 30 determines the current position of an armrest surface, such as surfaces 24 and 126. The controller 30 may receive position signals, indicative of the position and orientation of armrest surface, from the position sensors 54.

In step 102, the controller 30 determines a desired position of the armrest surface. The controller 30 may determine the desired position in response to the position of the adjustable vehicle systems and components 40. For example, the controller 30 may adjust the position and orientation of the armrest surface in response to the position and orientation of a seat system.

In step 104, the controller 30 adjusts the position of the armrest surface in response to the current position and the desired position.

When piston elements are utilized, one or more of the piston elements are actuated, as designated by box 104A. Fluid is supplied or removed to or from the extraction chambers and the retraction chambers of the piston elements, until said current position is approximately the same as the desired position. When actuating the piston elements a fluid may be passed in one or more flow directions including a piston fill direction, a piston evacuate direction, a fluid return direction, and a fluid release direction. The term “fill” refers to the supplying of fluid to the piston element. The term “evacuate” refers to the removal of fluid from the piston element. The term “return” refers to the removal of fluid from the piston element and passage thereof to a storage reservoir or the like from which it originated. The fluid in a first piston chamber may be returned to a second piston chamber, such as from a retraction chamber to an extension chamber. The term “release” refers to the removal of fluid from the piston element into a surrounding area.

When a fluid cell is utilized, the fluid cell is actuated, as designated by box 104B. Internal chambers of the fluid cell may be supplied fluid or fluid may be removed therefrom, such as in the case of the embodiment of FIG. 6. When the piston elements or the fluid cell is actuated stabilizing elements may be translated, as designated by box 104C.

The armrest surface may be linearly translated in a vertical direction or may be tilted in the above-stated directions. As the armrest surface is repositioned and oriented stabilizing elements, such as the sliding elements 130, may be translated, extended or retracted, to accommodate the varying separation distances between the armrest surface and that of an opposing surface of the armrest assembly. An example of an opposing surface is the upper surface 68.

The above-described steps are meant to be illustrative examples; the steps may be performed sequentially, synchronously, simultaneously, or in a different order depending upon the application.

The present invention provides a system for adjusting the position and orientation of an armrest surface. The present invention allows for an armrest surface to be adjusted independent of and in relation to the adjustment of vehicle systems and components. The present invention provides an armrest surface that may be manually adjusted or adjusted in response to the adjustment of other vehicle systems and components. Thus, the present invention accommodates for vehicle occupants of varying size and height and having varying position and orientation desires of vehicle systems and components, such as armrests, seats, steering wheels, and foot pedals.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1) An adjustable armrest system for a vehicle comprising:
at least one armrest housing mounted within the vehicle and having an armrest surface;
at least one piston element coupled to said at least one armrest surface;
at least one piston-actuating device coupled to said at least one piston element; and
a controller coupled to said at least one piston-actuating device and adjusting position of said at least one armrest surface.

2) A system as in claim 1 wherein said at least one piston element comprises:
a first piston element; and
a second piston element.

3) A system as in claim 2 wherein said first piston element and said second piston element stabilize said at least one armrest surface in at least one direction selected from fore, aft, left, and right directions.

4) A system as in claim 2 wherein said at least one piston element further comprises a third piston element, said first piston element, said second piston element, and said third piston element stabilizing said at least one armrest surface in fore, aft, left, and right directions.

5) A system as in claim 1 wherein said at least one piston element independently adjust tilt of said at least one armrest surface.

6) A system as in claim 1 wherein said at least one piston-actuating device comprises:
a first piston-actuating device associated with a first piston element; and
a second piston-actuating device associated with a second piston element.

7) A system as in claim 1 wherein said at least one piston-actuating device comprises at least one of an electrical motor, a fluidic actuating device, a pneumatic actuating device, and a hydraulic actuating device.

8) A system as in claim 1 wherein at least one piston element comprises at least one fluid passage port.

9) A system as in claim 8 wherein said at least one fluid passage port comprises:
an extension port; and
a retraction port.

10) A system as in claim 1 further comprising at least one valve coupled between said at least one piston element and said at least one piston-actuating device, said controller adjusting position of said at least one armrest surface via said at least one valve.

11) A system as in claim 10 wherein said at least one valve is a sequential valve.

12) A system as in claim 10 wherein said at least one valve comprises:
a supply valve; and
an evacuate valve.

13) A system as in claim 12 wherein said supply valve and said evacuate valve are coupled to and allow passage of fluid to and from at least one chamber of said at least one piston element.

14) A system as in claim 1 further comprising at least one spring element coupled to and assisting in the displacement of said at least one armrest surface and to said piston element.

15) A system as in claim 1 further comprising an armrest position sensor generating a position signal indicative of position of said at least one armrest surface, said controller adjusting position of said at least one armrest surface in response to said position signal.

16) An adjustable armrest system for a vehicle comprising:
at least one armrest housing mounted within the vehicle and having an armrest surface;
at least one fluid cell having a plurality of internal chambers coupled to said at least one armrest surface;
a plurality of stabilizing members coupled to said at least one armrest surface;
at least one pump coupled to said plurality of internal chambers; and
a controller coupled to said at least one pump and adjusting position and orientation of at least a portion of said at least one armrest surface.

17) A system as in claim 16 further comprising an armrest position sensor generating a position signal indicative of position of said at least one armrest surface, said controller adjusting position of said at least one armrest surface in response to said position signal.

18) A system as in claim 16 wherein said plurality of stabilizing members comprise:
a first stabilizing slider; and
a second stabilizing slider positioned on a different side of said at least one fluid cell than said first stabilizing slider.

19) A method of adjusting the position of a vehicle armrest comprising:
determining a current position of at least one armrest surface;
determining a desired position of said at least one armrest surface; and
adjusting position of said at least one armrest surface in response to said current position and said desired position comprising:
actuating at least one piston element; and
linearly translating at least one armrest surface stabilizing element other than said at least one piston element.

20) A method as in claim 20 wherein actuating at least one piston element comprises passing at least one fluid in at least one flow direction relative to said at least one piston selected from a piston fill direction, a piston evacuate direction, a fluid return direction, and a fluid release direction.
